(19) United States
(12) Patent Application Publication
(10) Pub. No.: US 2026/0163935 A1
(43) Pub. Date: Jun. 11, 2026

(54) METHOD, APPARATUS, DEVICE, MEDIUM AND PROGRAM PRODUCT FOR DATA RATE MEASUREMENT

(71) Applicants: Beijing Zitiao Network Technology Co., Ltd., Beijing (CN); Lemon Inc., Grand Cayman (KY)

(72) Inventors: Jing Liu, Beijing (CN); Bo Wang, Beijing (CN); Shu Shi, Los Angeles, CA (US)

(21) Appl. No.: 19/409,365

(22) Filed: Dec. 4, 2025

(30) Foreign Application Priority Data
Dec. 11, 2024 (CN) 202411824221.0

(51) Int. Cl. H04L 65/80; H04L 43/10; H04L 47/27; H04L 65/61

(52) U.S. Cl. CPC H04L 65/80; H04L 43/10; H04L 47/27; H04L 65/61

(57) ABSTRACT

Embodiments of the disclosure provides a method, an apparatus, a device, a computer-readable storage medium, and a computer program product for data rate measurement. The method includes: transmitting a first probing packet to a server based on a first transmission rate for the first probing packet; transmitting a second probing packet to the server based on a second transmission rate for the second probing packet, wherein a data amount of the second probing packet is less than a data amount of the first probing packet, and the second transmission rate is determined based on the first transmission rate; obtaining, within a target time period, a first rate measurement result associated with the first probing packet and a second rate measurement result associated with the second probing packet; and determining a target rate measurement result corresponding to the transmitted media information based on the first and second rate measurement results.

### CROSS-REFERENCE

The present application claims priority to Chinese Patent Application No. 202411824221.0, filed on Dec. 11, 2024 and entitled “METHOD, APPARATUS, DEVICE, MEDIUM AND PROGRAM PRODUCT FOR DATA RATE MEASUREMENT”, the entirety of which is incorporated herein by reference.

### FIELD

Example embodiments of the present disclosure generally relate to the field of computers, and in particular to a method, an apparatus, a device, a computer-readable storage medium, and a computer program product for data rate measurement.

### BACKGROUND

In a live streaming scenario, image quality and fluency are key indicators for evaluating the experience of both broadcasting and viewing the live stream. To optimize these key indicators, it is usually necessary to measure the network speed quickly and accurately because the network speed directly affects the presentation of image quality and the fluency of playback. After obtaining the network speed information, for example, the most suitable resolution may be recommended for the live streamer, thereby ensuring a good live streaming effect.

### SUMMARY

In a first aspect of the present disclosure, a method for data rate measurement is provided. The method comprises the following steps: transmitting a first probing packet to a server based on a first transmission rate for the first probing packet, wherein the first probing packet is configured to simulate media information transmitted in a media information transmission scenario; transmitting a second probing packet to the server based on a second transmission rate for the second probing packet, wherein a data amount of the second probing packet is less than a data amount of the first probing packet, and the second transmission rate is determined based on the first transmission rate; obtaining, within a target time period, a first rate measurement result associated with the first probing packet and a second rate measurement result associated with the second probing packet; and determining a target rate measurement result corresponding to the transmitted media information based on the first rate measurement result and the second rate measurement result.

In a second aspect of the present disclosure, an apparatus for data rate measurement is provided. The apparatus includes: a first probing packet transmission module configured to transmit a first probing packet to a server based on a first transmission rate for the first probing packet, wherein the first probing packet is configured to simulate media information transmitted in a media information transmission scenario; a second probing packet transmission module configured to transmit a second probing packet to the server based on a second transmission rate for the second probing packet, wherein a data amount of the second probing packet is less than a data amount of the first probing packet, and the second transmission rate is determined based on the first transmission rate; and a rate measurement result obtaining module configured to obtain, within a target time period, a first rate measurement result associated with the first probing packet and a second rate measurement result associated with the second probing packet; and a rate measurement result determining module configured to determine a target rate measurement result corresponding to the transmitted media information based on the first rate measurement result and the second rate measurement result.

In a third aspect of the present disclosure, an electronic device is provided. The electronic device includes at least one processor; and at least one memory coupled to the at least one processor and storing instructions for execution by the at least one processor. The instructions, when executed by the at least one processor, cause the electronic device to perform the method of the first aspect.

In a fourth aspect of the present disclosure, a computer-readable storage medium is provided. The computer-readable storage medium stores a computer program, and when the computer program is executed by the processor, the method in the first aspect is implemented.

In a fifth aspect of the present disclosure, a computer program product is provided. The computer program product includes a computer program, and when the computer program is executed by a processor, the method in the first aspect is implemented.

It should be understood that the content described in this section is not intended to limit the key features or important features of the embodiments of the present disclosure, nor is it intended to limit the scope of the present disclosure. Other features of the present disclosure will become readily understood from the following description.

### BRIEF DESCRIPTION OF DRAWINGS

The above and other features, advantages, and aspects of various embodiments of the present disclosure will become more apparent from the following detailed description taken in conjunction with the accompanying drawings. In the drawings, the same or similar reference numbers refer to the same or similar elements, wherein:

FIG. 1 illustrates a schematic diagram of an example environment in which embodiments of the present disclosure can be implemented;

FIG. 2 shows a schematic diagram of an architecture for data rate measurement according to some embodiments of the present disclosure;

FIG. 3 shows a flowchart of a method for data rate measurement according to some embodiments of the present disclosure;

FIG. 4 shows a schematic structural block diagram of an apparatus for data rate measurement according to some embodiments of the present disclosure; and

FIG. 5 illustrates a block diagram of an electronic device in which one or more embodiments of the present disclosure may be implemented.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms, and should not be construed as limited to the embodiments set forth herein, but rather, these embodiments are provided for a more thorough and complete understanding of the present disclosure. It should be understood that the drawings and embodiments of the present disclosure are for exemplary purposes only and are not intended to limit the scope of the present disclosure.

In the description of embodiments of the present disclosure, the terms “including” and the like should be understood to include “including but not limited to”. The term “based on” should be understood as “based at least in part on”. The terms “one embodiment” or “the embodiment” should be understood as “at least one embodiment”. The term “some embodiments” should be understood as “at least some embodiments”. Other explicit and implicit definitions may also be included below.

Herein, unless explicitly stated, “responding to A” performs one step and does not imply that this step is performed immediately after “A”, but may include one or more intermediate steps.

It may be understood that the data involved in the technical solution (including but not limited to the data itself, the obtaining, using, storing or deleting of the data) should follow the requirements of the corresponding laws and regulations and related regulations.

It can be understood that before using the technical solutions disclosed in the embodiments of the present disclosure, relevant users should be informed of the types, use ranges, usage scenarios, and the like of the information related to the present disclosure in an appropriate manner according to relevant laws and regulations, and the authorization of the related users may be obtained, wherein the relevant users may include any type of rights body, such as individuals, businesses, and groups.

For example, when an active request of a user is received, prompt information is sent to the related user to explicitly prompt the related user, and the operation requested to be performed will need to obtain and use the information of the related user, so that the related user can autonomously select whether to provide information to software or hardware executing the operation of the technical solution of the present disclosure according to the prompt information.

As an optional but non-limiting implementation, in response to receiving an active request of a related user, a manner of sending prompt information to the related user may be, for example, a pop-up window, and prompt information may be presented in a text manner in the pop-up window. In addition, the pop-up window may further carry a selection control for the user to select “agree” or “not agree” to provide information to the electronic device.

It may be understood that the foregoing notification and obtaining a user authorization process are merely illustrative, and do not constitute a limitation on implementations of the present disclosure, and other manners of meeting related laws and regulations may also be applied to implementations of the present disclosure.

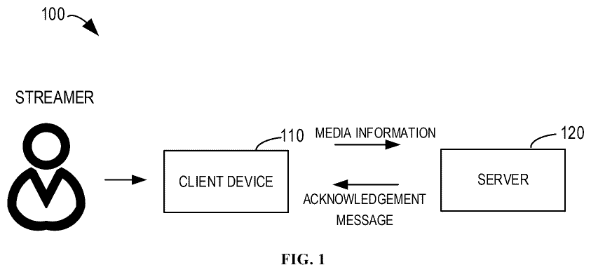

FIG. 1 illustrates a schematic diagram of an example environment 100 in which embodiments of the present disclosure can be implemented. The environment 100 relates to a client device 110 and a server 120. A transmission initiator (for example, a live streamer) may transmit media information in a media information transmission scenario (for example, a live streaming scenario, an on-demand scenario, an audio/video transmission scenario, and the like) by using the client device 110. The client device 110 may communicate with server 120 to provide other users with services related to the transmitted media information via server 120. The client device 110 may be configured to perform data rate measurement tasks.

The client device 110 may be any type of device having computing capability, including a terminal device or a server device. The terminal device may be any type of mobile terminal, fixed terminal, or portable terminal, including a mobile handset, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/camcorder, a pointing device, a television receiver, a radio broadcast receiver, an e-book device, a gaming device, or any combination of the foregoing, including accessories and peripherals of these devices, or any combination thereof. The server device may include, for example, a computing system/server, such as a mainframe, an edge computing node, a computing device in a cloud environment, or the like.

It should be understood that the structure and function of the environment 100 is described for illustrative purposes only and does not imply any limitation to the scope of the present disclosure.

As briefly mentioned above, in the live streaming scenario, in order to ensure image quality and fluency, it is usually necessary to quickly and accurately measure the network speed, so as to recommend the most suitable resolution for the streamer. In one solution, the speed and accuracy of speed measurement may be improved by a statistical sampling method of fuzzy rejection sampling. This speed measurement method is essentially a passive speed measurement method, that is, the network speed is estimated based on the actually transmitted data amount. The method generally adopts a flooding type packet sending mechanism, and has the advantage that the influence of network noise interference can be effectively avoided.

However, the above method suffers from the problem of inaccurate speed measurement when the preview duration before the start of live streaming. For example, when a streamer's preview duration before starting live streaming is relatively short (for example, less than 2 seconds), or the overhead for establishing the transmission protocol connection is relatively high, resulting in a short effective speed measurement duration (for example, less than 2 seconds), the speed measurement result based on the foregoing method may have a greater probability of inaccuracy.

For this inaccurate situation, a non-confidence process may be performed in practical applications, that is, the speed measurement result at this time is discarded. This means that the appropriate resolution will not be recommended for the streamer according to the network situation. From an overall global perspective, the penetration rate of the broadcast speed measurement function for the start of the live stream is affected.

In another solution, a small amount of probe data packets may be actively sent through a non-flooding packet sending mechanism, and then a network bandwidth capacity size may be indirectly inferred by using some mathematical models. For example, a packet interval model is configured to infer bandwidth based on time interval information of the packet. For another example, a plurality of packet sending rate models are configured to explore possible highest bandwidth capacity that may not cause congestion. An advantage of such a method is lightweight, high efficiency.

Compared with a passive speed measurement method, the active speed measurement method can use shorter time and fewer packets and can be processed through a filtering algorithm to derive the speed measurement result quickly. However, due to the problem of more network delay jitter or packet loss, as well as a problem of queue management policy limitation (such as token bucket speed limit) of the router, both the time information and the sending rate of the packet transmission in the active speed measurement method are affected, causing it to become more sensitive, leading to the results measured by the active speed measurement method becoming unstable and inaccurate.

In embodiments of the present disclosure, an improved solution for data rate measurement is provided. The solution can run two rate measurement methods simultaneously, to enhance the reliability, stability and accuracy of the rate measurement system and algorithm in large-scale applications. In this solution, based on a first transmission rate for a first probing packet, a client device transmits the first probing packet to the server. The first probing packet is configured to simulate media information transmitted in a media information transmission scenario. Based on a second transmission rate for a second probing packet, the client device transmits the second probing packet to the server. A data amount of the second probing packet is less than a data amount of the first probing packet, and the second transmission rate is determined based on the first transmission rate. Within a target time period, the client device obtains a first rate measurement result associated with the first probing packet and a second rate measurement result associated with the second probing packet. Based on the first rate measurement result and the second rate measurement result, the client device determines a target rate measurement result corresponding to the transmitted media information.

In this way, the accuracy of the rate measurement result under the constraint of a short effective rate measurement duration can be improved, and the global penetration rate of the rate measurement function on the transmission initiator's side can be improved. In the rate measurement system of the present disclosure, two rate measurement methods are simultaneously run, and rate measurement results of the two rate measurement methods may be fused according to actual effective rate measurement durations, thereby obtaining rate measurement results that may be used for subsequent processing (for example, determining image resolution for transmitted media information).

Some example embodiments of the present disclosure will be described in detail below with reference to the drawings and with live streaming scenes and the transmission of live stream data as examples. It should be understood that the present disclosure may be applicable to any suitable media information transmission scenario and any suitable form and transmission mode of media information, and the following example implementations do not imply any limitation on the scope of the present disclosure.

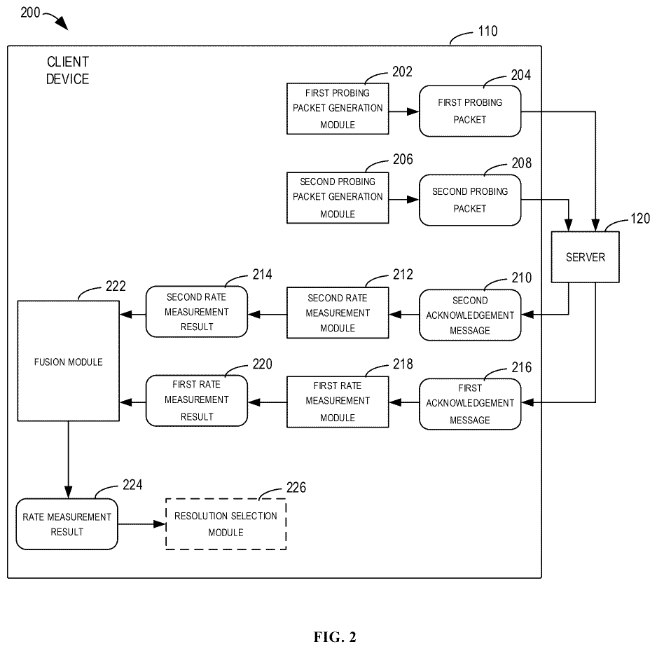

FIG. 2 shows a schematic diagram of an architecture 200 for data rate measurement according to some embodiments of the present disclosure. The architecture 200 may be implemented in the environment 100 of FIG. 1, such as through a client device 110 and a server 120 in the environment 100. The following will be described with reference to FIG. 1.

The client device 110 includes a first probing packet generation module 202 and a second probing packet generation module 206. The first probing packet generation module 202 generates the first probing packet 204 based on the first transmission rate. The first probing packet 204 is configured to simulate live streaming data. The client device 110 transmits the first probing packet 204 to the server 120 for live streaming. Further, the client device 110 determines the second transmission rate based on the first transmission rate. The second probing packet generation module 206 generates the second probing packet 208 based on the second transmission rate. A data amount of the second probing packet 208 is less than a data amount of the first probing packet 204. The client device 110 transmits the second probing packet 208 to the server 120.

The server 120 is configured to receive the probing packet and return an acknowledgement message for the probing packet. Specifically, the server 120 receives the first probing packet 204 from the client device 110 and sends a first acknowledgment message 216 for the first probing packet 204 to the client device 110. The server 120 receives the second probing packet 208 from the client device 110 and sends a second acknowledgment message 210 for the second probing packet 208 to the client device 110.

The client device 110 also includes a first rate measurement module 218 and a second rate measurement module 212. Within a target time period (e.g., a time period of actual rate measurement), the first rate measurement module 218 is configured to receive the first acknowledgment message 216 and output a first rate measurement result 220 associated with the first probing packet 204. The second rate measurement module 212 is configured to receive the second acknowledgment message 210 and output a second rate measurement result 214 associated with the second probing packet 208.

The client device 110 also includes a fusion module 222. The fusion module 222 is configured to receive the first rate measurement result 220 and the second rate measurement result 214. Based on the two rate measurement results, the fusion module 222 is further configured to output a fused rate measurement result 224 corresponding to the live streaming data transmission.

In some implementations, the client device 110 may determine the image resolution for the live streaming based on the fused rate measurement result 224. For example, the client device 110 may also include a resolution selection module 226. The resolution selection module 226 is configured to receive the fused rate measurement result 224 and may determine an image resolution for the live streaming based on the rate measurement result.

The architecture 200 for data rate measurement is described above with reference to FIG. 2. Based on the architecture 200, the present disclosure further provides two probing mechanisms, which are described below with reference to embodiments.

According to the first probing mechanism, the client device 110 sends the first probing packet 204 to the server 120, and receives the first acknowledgement message 216 from the server 120. Specifically, the first probing packet generation module 202 may simulate the video data generated by the streamer push stream to generate the first probing packet. For example, the client device 110 may generate original video data by constructing some fake data, and send such original video data to the encoder to compress the original video data to a target bitrate interval (for example, a bitrate interval preset based on a default bitrate, a maximum bitrate, and a minimum bitrate), so as to generate live streaming data meeting a required data bitrate size. Such simulated live streaming data may be used as the first probing packet 204.

In some implementations, the first probing packet 204 may be generated by an application layer of the client device 110. Based on the first transmission rate for the first probing packet 204, the first probing packet 204 may be transmitted to the server 120 by a transport layer of the client device 110. For example, the live streaming data may be generated at an application layer of the client device 110 and processed through a transport layer. For example, the first probing packet generation module 202 includes an application layer data generation module and a transport layer pacer uniform sending module (not shown in FIG. 2). The application layer data generation module is configured to generate the live streaming data. The generated live streaming data is input to a transport layer pacer uniform sending module. The transport layer pacer uniform sending module is configured to transmit the live streaming data to the server 120 at a preset rate, thereby adjusting the data transmission rate, and achieving the purpose of flow control and data transmission stability.

After receiving the first probing packet 204, the server 120 returns the first acknowledgment message 216. The first acknowledgement message 216 may be received at the transport layer of the client device 110 and processed to generate the first rate measurement result 220 at the application layer. In some implementations, the target time period may include a plurality of time units. For each time unit, based on the first acknowledgment message 216 from the server 120 for the first probing packet 204 received by the transport layer of the client device 110, the client device 110 may determine a transport layer rate measurement result, to obtain a plurality of transport layer rate measurement results respectively corresponding to the plurality of time units. Further, based on the plurality of transport layer rate measurement results, the client device 110 may determine at least one application layer rate measurement result, thereby determining the first rate measurement result 220 based on the at least one application layer rate measurement result.

For example, the first rate measurement module 218 includes a transport layer rate measurement module and an application layer rate measurement module (not shown in FIG. 2). The transport layer rate measurement module includes two parts: a transmission protocol and a transmission algorithm. The transmission protocol is, for example, a user state transmission protocol, and the transmission algorithm is, for example, a congestion control algorithm (for example, a slow start algorithm). The transport layer rate measurement module is configured to calculate an intermediate rate based on an acknowledgment mechanism (i.e., an Ack mechanism) and a congestion control algorithm. The intermediate rate is sent to the application layer rate measurement module. The application layer rate measurement module is configured to periodically obtain the intermediate rate from the transport layer rate measurement module by using a preset time interval. The application layer rate measurement module is further configured to determine a first rate measurement result 220 based on the plurality of intermediate rates within a preset time period.

The first probing mechanism is described above with reference to the examples. The first probing mechanism may perform data transmission and confirmation based on the transport layer transmission protocol, that is, acknowledge whether the data packet sent by the application layer for the rate measurement function is received by the server based on a faster and more accurate packet acknowledgment mechanism, thereby improving the accuracy of the rate measurement. Further, a probing mechanism for cross-layer optimization is implemented by combining the generation and calculation methods of optimization probing packets at the transport layer with the application layer.

It should be understood that the idea of the first probing mechanism is to simulate a passive rate measurement method, and any suitable passive rate measurement method may be configured to generate the first rate measurement result 220, which is not limited in the present disclosure. The second probing mechanism is described below with reference to embodiments. The idea of the second probing mechanism is to obtain the second rate measurement result 214 by using an active rate measurement method without affecting the first probing mechanism. The specific description is as follows.

According to a second probing mechanism, the client device 110 sends a second probing packet 208 to the server 120 and receives a second acknowledgement message 210 from the server 120. Specifically, the second probing packet generation module 206 may generate the second probing packet 208 based on the related parameter of the first probing mechanism. For example, the first probing packet generation module 202 generates the first probing packet 204 by using a congestion control algorithm. The second probing packet generation module 206 may determine the second transmission rate and the probing period of the second probing packet 208 based on some preset parameters in the congestion control algorithm (such as a congestion control window size, a probing rate of the first probing packet 204, a probing period, and the like) and a parameter (such as a minimum round-trip time of the first probing packet) measured by the congestion control algorithm.

In some embodiments, the client device 110 may determine the probing period probe_duration for the second probing packet 208 based on the exponential growth function of the preset probing period and the minimum round-trip time measured for the first probing packet 204. An example is as follows:

$$f ( duration ) = init\_duration * {2}^{t} , \qquad ( 1 )$$

$$probe\_duration = min ( min\_rtt , f ( duration ) ) , \qquad ( 2 )$$

wherein init_duration represents the preset probing period (for example, the preset initial probing period for the second probing packet, for example, 5 ms), t represents a round-trip time (RTT) unit (for example, a round-trip time set for the first probing packet), min_rtt represents a minimum round-trip time (for example, a minimum round-trip time measured for the first probing packet), and ƒ(duration) represents an exponential growth function of the preset probing period.

In some embodiments, in a scenario in which a network congestion control algorithm is used, a round-trip time refers to a time elapsed from when the client device 10 sends a data package to the server 120, to when a acknowledge packet is returned from the server 120 to the client device 110, and min_rtt is a minimum value obtained after the round-trip times are counted within a period of time. It can be seen from equation (2) that the probing period probe_duration of the second probing packet selects a relatively smaller value between the minimum round trip time min_rtt and the exponential growth function ƒ(duration). In this way, the client device 110 may run two rate measurement methods at the same time, and avoid a problem that the transmission of the second probing packet may affect the transmission of the first probing packet due to an excessively large calculated value from the exponential growth function ƒ(duration).

In some implementations, to determine the second transmission rate, the client device 110 may obtain an exponential growth function ƒ(duration) of the preset probing period and a congestion control window size for the first probing packet 204. Based on the exponential growth function ƒ(duration), the congestion control window size, and the first transmission rate, the client device 110 may determine the second transmission rate probe_rate. An example is as follows:

$$rate = cwnd / f ( duration ) , \qquad ( 3 )$$

$$probe\_rate = max ( rate * discoun\_ratio , pacing\_rate ) , \qquad ( 4 )$$

wherein cwnd represents the congestion control window size of the congestion control algorithm for the first probing packet, pacing_rate represents the first transmission rate of the first probing packet set by the congestion control algorithm, and discoun_ratio represents the adjustable transmission rate parameter (for example, less than or equal to 1). discoun_ratio can serve to balance the maximum bandwidth that may be probed by the second probing packet 208 may be balanced without affecting the transmission of the first probing packet.

According to the probing period for the second probing packet 208, the client device 110 transmits the second probing packet 208 to the server 120 at the second transmission rate. Similarly to the first rate measurement module 218, the second rate measurement module 212 may utilize a congestion control algorithm to determine the second rate measurement result 214 based on the acknowledge mechanism.

The client device 110 obtains the first rate measurement result 214 and the second rate measurement result 220 within the target time period. In some implementations, the target time period may include a plurality of time units. Within each time unit, the client device 110 may send the second probing packet 208 at a second transmission rate with a fraction of the time. In order not to change the congestion window size for the first probing packet 204, the data amount of the second probing packet 208 is less than the data amount of the first probing packet 204.

In some embodiments, in each time unit, the client device 110 may transmit the second probing packet 208 to the server 120 at the second transmission rate within the first probing period, and transmit the first probing packet 204 to the server 120 at the first transmission rate within the second probing period after the first probing period. For example, within each time unit, starting from when the start state flag of the current round is timed, the client device 110 sends the second probing packet 208 for a duration of probe_duration at the second transmission rate probe_rate. After the first probing period ends, the client device 110 transmits the first probing packet 204 at the first transmission rate within the remaining time of the current round. In this way, the purpose of two probing mechanisms being run at the same time, and the rate measurement result being not affected with each other can be achieved.

In some embodiments, in each time unit, the client device 110 may determine a candidate rate measurement result based on the second acknowledgment message 210 of the server 120 for the second probing packet 208, to obtain a plurality of candidate rate measurement results respectively corresponding to the plurality of time units. The client device 110 may determine the second rate measurement result 220 based on the plurality of candidate rate measurement results.

In some embodiments, the client device 110 may determine the data amount of the second probing packet 208 in response to receiving the second acknowledgment message 210, so as to determine the candidate rate measurement result based on the data amount and the first probing period. For example, in each time unit, when the start state flag of the current round is 1 and the probing sending completion state for this round is 0, upon receiving the acknowledgement message for the first second probing packet 208 sent, the client device 110 may mark the start of the rate measurement sampling for the current round. The client device 110 may record the initial sent byte count probe_delivered_start of the probing and the initial timestamp probe_time_start of the probing at this time. Thereafter, each new acknowledgment message for the second probing packet 208 triggers the client device 110 to calculate the candidate rate measurement result.

Based on the plurality of candidate rate measurements, the client device 110 may determine a second rate measurement result 214. For example, the client device 110 determines the candidate rate measurement result speed_sample based on the data amount delivered_bytes (for example, the byte count) of the second probing packet 208 that has been sent in each time unit and the first probing period probe_duration. An example is as follows:

$$speed\_sample = delivered\_bytes / probe\_duration , \qquad ( 5 )$$

$$delivered\_bytes = total\_acked \_bytes - probe\_delivered \_start , \qquad ( 6 )$$

$$probe\_duration = now - probe\_time \_start , \qquad ( 7 )$$

wherein total_acked_bytes represents the byte count sent using the congestion control algorithm for the second probing packet, probe_delivered_start represents the initial sent byte count of the probing, and now is the current timestamp of the system, probe_time_start is the initial timestamp of the probing. Through the above formula, each time a candidate rate measurement result speed_sample is obtained, it is added to the array speed_sample_list for storage.

When the measurement with the second probing packet ends, the client device 110 filters all candidate rate measurement results and calculates the second rate measurement result 214. For example, the client device 110 sorts the candidate rate measurement results in the array peed_sample_list from small to large according to a numerical value, and removes the bottom a % and the top b % of the candidate rate measurement results in the array. If the number of remaining valid candidate rate measurement results is greater than the preset parameter value c (for example, c=3), their average value is calculated to obtain the final second rate measurement result 214. If the number of remaining valid candidate rate measurement results is less than or equal to the preset parameter value c, the rate measurement result in the target time period is invalid and is not used for the subsequent processing.

The second probing mechanism is described in the above embodiments. Based on the rate measurement results of the two probing mechanisms, the client device 110 may perform a fusion calculation to improve accuracy of rate measurement results within a shorter time period. Details are described below in connection with embodiments.

In some implementations, if the duration of the target time period is less than the first duration threshold and greater than the second duration threshold, the client device 110 may use the second rate measurement result 214 as the rate measurement result 224. If the duration of the target time period is greater than the first duration threshold and less than the third duration threshold, the client device 110 may determine the rate measurement result 224 based on the first rate measurement result 220, the second rate measurement result 214, and the preset confidence factor.

For example, the target time period is the actual measurement duration x. The first duration threshold is set as an effective measurement duration threshold e for the second probing packet, and the second duration threshold is an effective measurement duration threshold d for the first probing packet. Considering the active probing mechanism, the rate measurement result can be quickly obtained with a shorter time, so e<d. An example of a fusion mechanism proposed by the present disclosure is as follows.

If x<e, i.e., no valid measurement for the second probing packet is reached, the client device 110 determines the rate measurement result 224 as not effective, i.e., will not be used as a reference for subsequent processing. If e≤x<d, that is, the valid measurement for the second probing packet is reached, but no valid measurement for the first probing packet is reached, the client device 110 uses the second rate measurement result 214 as the rate measurement result 224. If x≥d, meaning the effective measurement for the first probing packet has been reached, considering the higher accuracy of the rate measurement result brought by the cross-layer optimization of the first probing mechanism, the client device 110 may use the first rate measurement result 220 as the rate measurement result 224.

The third duration threshold is a threshold (for example, 2 s) for a shorter duration corresponding to the desired improvement in the accuracy of the rate measurement result. In some scenarios, the setting of the third duration threshold may affect the algorithm of the fusion mechanism. For example, when d=2, the client device 110 may obtain the rate measurement result 224 by using the above example. When d<2, the client device 110 may obtain the rate measurement result 224 using the following example.

If x<e, i.e., no valid measurement for the second probing packet is reached, the client device 110 determines the rate measurement result 224 as not valid. If e≤x<d, that is, the valid measurement for the second probing packet is reached, but no valid measurement for the first probing packet is reached, the client device 110 uses the second rate measurement result 214 as the rate measurement result 224. If d<x<2, the client device 110 may introduce a confidence factor q to determine the measurement result. For example, rate measurement result 224=q*second rate measurement result 214+(1−q)*first rate measurement result 220, where 0<q<1. If x≥2, the client device 110 may use the first rate measurement result 220 as the rate measurement result 224.

In some implementations, the client device 110 may also determine the rate measurement result based on a minimum round-trip time min_rtt measured for the first probing packet. In this way, different confidence calculation may be performed by using the relationship between min_rtt, the actual rate measurement duration x, the effective measurement duration threshold e for the second probing packet, and the effective measurement duration threshold d for the first probing packet, to determine the rate measurement result with higher accuracy.

As an example, when d≥2, the client device 110 may obtain the rate measurement result 224 by using the following example. For example, if x<e, the client device 110 determines that the rate measurement result 224 is not in effect (e.g., setting the rate measurement result 224 to 0). If e≤x<d, the client device 110 uses the second rate measurement result 214 as the rate measurement result 224. If x≥d and min_rtt<fourth duration threshold f, the client device 110 may use the first rate measurement result 220 as the rate measurement result 224. If x≥d and min_rtt≥fourth duration threshold f, client device 110 may use second rate measurement result 214 as rate measurement result 224. The fourth duration threshold f represents a high RTT threshold judgment parameter, which may be preset for judging whether the round-trip time is too high. For example, f=400 ms, which means that when the actual measured round trip time exceeds 400 ms, the network may have serious congestion or other abnormal conditions.

As another example, when d<2, the client device 110 may obtain the rate measurement result 224 using the following example. For example, if x<e, the client device 110 determines that the rate measurement result 224 is not in effect (e.g., setting the rate measurement result 224 to 0). If d<x<2, then rate measurement result 224=q*second rate measurement result 214+(1−q)*first rate measurement result 220, where 0<q<1. If x≥2 and min_rtt<fourth duration threshold f, the client device 110 may use the first rate measurement result 220 as the rate measurement result 224. If x≥2 and min_rtt≥fourth duration threshold f, client device 110 may use second rate measurement result 214 as rate measurement result 224.

The fusion mechanism of the present disclosure is described above in connection with the embodiments. It should be understood that the values listed herein are for the purpose of clarity of description and do not imply any limitation on the scope of the present disclosure.

In conclusion, the present disclosure provides an example architecture that can run two probing mechanisms at the same time, and the second probing mechanism can perform rate measurement at a relatively small proportion of probing period and data amount without changing a congestion control window of the first probing mechanism, to ensure that the two probing mechanisms run simultaneously and do not affect each other. The present disclosure further provides a fusion mechanism, which performs confidence calculation through the relationship between the actual rate measurement duration and the effective rate measurement duration threshold and/or the minimum round-trip time of the two probing methods, thereby improving the accuracy of rate measurement for short duration (for example, 2 seconds and below), and improving the penetration rate of the rate measurement function on the transmission initiator's side in large-scale business applications. In other words, the present disclosure can ensure, in large-scale deployments, the stability and accuracy for the measurement duration of 2 seconds or more are not affected.

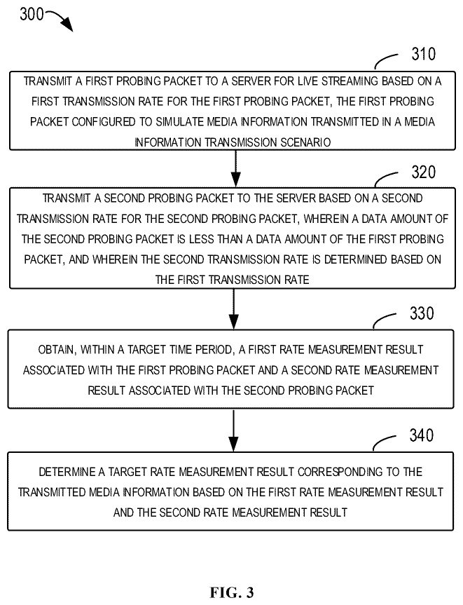

FIG. 3 shows a flowchart of a method 300 for data rate measurement according to some embodiments of the present disclosure. The method 300 may be implemented at the client device 110 of FIG. 1. The method 300 is described below with reference to FIG. 1.

In block 310, the client device 110 transmits the first probing packet to the server based on the first transmission rate for the first probing packet. The first probing packet is configured to simulate media information transmitted in a media information transmission scenario.

At block 320, the client device 110 transmits a second probing packet to the server based on the second transmission rate for the second probing packet. A data amount of the second probing packet is less than a data amount of the first probing packet. The second transmission rate is determined based on the first transmission rate.

At block 330, the client device 110 obtains, within a target time period, a first rate measurement result associated with the first probing packet and a second rate measurement result associated with the second probing packet.

At block 340, the client device 110 determines a target rate measurement result corresponding to the transmitted media information based on the first rate measurement result and the second rate measurement result.

In some embodiments, the second transmission rate is determined in the following manner: the client device 110 obtains an exponential growth function of the preset probing period and a congestion control window size for the first probing packet; and determines the second transmission rate based on the exponential growth function, the congestion control window size, and the first transmission rate.

In some embodiments, the method 300 includes: determining a probing period for the second probing packet based on an exponential growth function of a preset probing period and a minimum round-trip time measured for the first probing packet; and transmitting the second probing packet to the server at the second transmission rate according to the probing period for the second probing packet.

In some implementations, the target time period includes a plurality of time units. The method 300 includes: for one of a plurality of time units, transmitting a second probing packet to a server at a second transmission rate within a first probing period; and transmitting the first probing packet to the server at a first transmission rate within a second probing period after the first probing period.

In some embodiments, the method 300 includes: for each of the plurality of time units, determining a candidate rate measurement result based on a second acknowledgment message of the server for the second probing packet, to derive a plurality of candidate rate measurement results respectively corresponding to the plurality of time units; and determining a second rate measurement result based on the plurality of candidate rate measurement results.

In some embodiments, the method 300 includes: in response to receiving the second acknowledgment message, determining a data amount of the second probing packet; and determining a candidate rate measurement result based on the data amount and the first probing period.

In some implementations, the method 300 includes: generating, by an application layer of a client device, a first probing packet, the client device being associated with a transmission initiator of the media information transmission scenario; and transmitting, by a transport layer of the client device, the first probing packet to the server based on the first transmission rate for the first probing packet.

In some embodiments, the method 300 includes: for each of a plurality of time units, determining a transport layer rate measurement result based on a first acknowledgment message of a server received by a transport layer of the client device for the first probing packet, to derive a plurality of transport layer rate measurement results respectively corresponding to the plurality of time units; determining at least one application layer rate measurement result based on the plurality of transport layer rate measurement results; and determining a first rate measurement result based on the at least one application layer rate measurement result.

In some embodiments, the method 300 includes: using the second rate measurement as a rate measurement result if the duration of the target time period is less than a first duration threshold and greater than a second duration threshold; and determining the rate measurement result based on the first rate measurement result, the second rate measurement result, and the preset confidence factor if the duration of the target time period is greater than the first duration threshold and less than the third duration threshold.

In some embodiments, the method 300 includes: using the first rate measurement result as the rate measurement result if the duration of the target period is greater than or equal to a second duration threshold and a minimum round-trip time measured for the first probing packet is less than a fourth duration threshold; and using the second rate measurement as the rate measurement if the duration of the target time period is greater than or equal to the second duration threshold and the minimum round-trip time measured for the first probing packet is greater than or equal to the fourth duration threshold.

In some implementations, the method 300 further includes determining an image resolution for the transmitted media information based on the rate measurement result.

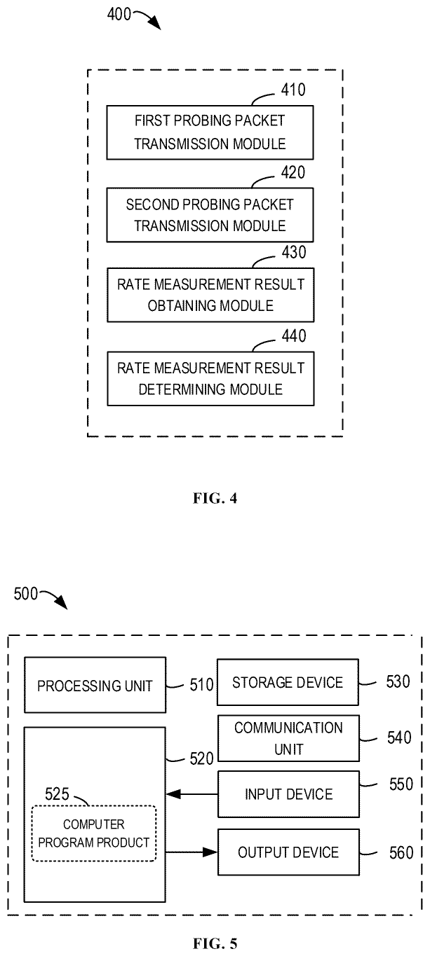

FIG. 4 shows a schematic structural block diagram of an apparatus 400 for data rate measurement according to some embodiments of the present disclosure. The apparatus 400 may be implemented, for example, in or included in the client device 110 of FIG. 1. The various modules/components in the apparatus 400 may be implemented by hardware, software, firmware, or any combination thereof. The apparatus 400 is described below with reference to FIG. 1.

As shown, the apparatus 400 includes a first probing packet transmission module 410 configured to transmit a first probing packet to a server based on a first transmission rate for the first probing packet, where the first probing packet is used to simulate media information transmitted in a media information transmission scenario. The apparatus 400 further includes a second probing packet transmission module 420 configured to transmit a second probing packet to the server based on a second transmission rate for the second probing packet. A data amount of the second probing packet is less than a data amount of the first probing packet, and the second transmission rate is determined based on the first transmission rate. The apparatus 400 further includes a rate measurement result obtaining module 430 configured to obtain, within a target time period, a first rate measurement result associated with the first probing packet and a second rate measurement result associated with the second probing packet. The apparatus 400 further includes a rate measurement result determining module 440 configured to determine a target rate measurement result corresponding to the transmitted media information based on the first rate measurement result and the second rate measurement result.

In some embodiments, the second transmission rate is determined by: obtaining an exponential growth function of the preset probing period and a congestion control window size for the first probing packet; and determining the second transmission rate based on the exponential growth function, the congestion control window size, and the first transmission rate.

In some embodiments, the second probing packet transmission module 420 may be specifically configured to: determine a probing period for the second probing packet based on an exponential growth function of the preset probing period and a minimum round-trip time measured for the first probing packet; and transmit the second probing packet to the server at the second transmission rate according to the probing period for the second probing packet.

In some implementations, the target time period includes a plurality of time units. The second probing packet transmission module 420 may be specifically configured to: for one of the plurality of time units, transmit the second probing packet to the server at the second transmission rate within a first probing period. The first probing packet transmission module 410 may be specifically configured to transmit the first probing packet to the server at the first transmission rate within the second probing period after the first probing period.

In some embodiments, the rate measurement result obtaining module 430 may be specifically configured to: for each of the plurality of time units, determine a candidate rate measurement result based on a second acknowledgment message of the server for the second probing packet, to derive a plurality of candidate rate measurement results respectively corresponding to the plurality of time units; and determine a second rate measurement result based on the plurality of candidate rate measurement results.

In some embodiments, the rate measurement result obtaining module 430 may be specifically configured to: in response to receiving the second acknowledgment message, determine a data amount of the second probing packet; and determine a candidate rate measurement result based on the data amount and the first probing period.

In some embodiments, the first probing packet transmission module 410 may be specifically configured to: generate, by an application layer of the client device, the first probing packet, where the client device is associated with a transmission initiator of the media information transmission scenario; and transmit, by a transport layer of the client device, the first probing packet to the server based on the first transmission rate for the first probing packet.

In some embodiments, the rate measurement result obtaining module 430 may be specifically configured to: for each time unit in the plurality of time units, determine a transport layer rate measurement result based on a first acknowledgment message of the server for the first probing packet received by the transport layer of the client device, to derive a plurality of transport layer rate measurement results respectively corresponding to the plurality of time units; determine at least one application layer rate measurement result based on the plurality of transport layer rate measurement results; and determine the first rate measurement result based on the at least one application layer rate measurement result.

In some embodiments, the rate measurement result determining module 440 may be specifically configured to: if a duration of the target time period is less than a first duration threshold and greater than a second duration threshold, use the second rate measurement result as the rate measurement result; and if the duration of the target time period is greater than the first duration threshold and less than the third duration threshold, determine the rate measurement result based on the first rate measurement result, the second rate measurement result, and the preset confidence factor.

In some embodiments, the rate measurement result determining module 440 may be specifically configured to: use the first rate measurement result as the rate measurement result if a duration of the target time period is greater than or equal to a second duration threshold and a minimum round-trip time measured for the first probing packet is less than a fourth duration threshold; and use the second rate measurement result as the rate measurement result if the duration of the target time period is greater than or equal to the second duration threshold and the minimum round-trip time measured for the first probing packet is greater than or equal to the fourth duration threshold.

In some embodiments, the apparatus 400 further includes: an image resolution determining module configured to determine an image resolution for the transmitted media information based on the rate measurement result.

FIG. 5 illustrates a block diagram of an electronic device 500 in which one or more embodiments of the present disclosure may be implemented. It should be understood that the electronic device 500 illustrated in FIG. 5 is merely exemplary and should not constitute any limitation on the functionality and scope of the embodiments described herein. The electronic device 500 shown in FIG. 5 may include or be implemented as the client device 110 or the server 120 of FIG. 1.

As shown in FIG. 5, the electronic device 500 is in the form of a general-purpose electronic device. Components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor and capable of performing various processes according to programs stored in the memory 520. In multiprocessor systems, multiple processing units execute computer-executable instructions in parallel to improve parallel processing capabilities of electronic device 500.

Electronic device 500 typically includes a plurality of computer storage media. Such media may be any available media accessible to the electronic device 500, including, but not limited to, volatile and non-volatile media, removable and non-removable media. The memory 520 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 530 may be a removable or non-removable medium and may include a machine-readable medium, such as a flash drive, magnetic disk, or any other medium, which may be capable of storing information and/or data and may be accessed within electronic device 500.

The electronic device 500 may further include additional removable/non-removable, volatile/non-volatile storage media. Although not shown in FIG. 5, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 520 may include a computer program product 525 having one or more program modules configured to perform various methods or actions of various embodiments of the present disclosure.

The communication unit 540 is configured to communicate with another electronic device through a communication medium. Additionally, the functionality of components of the electronic device 500 may be implemented in a single computing cluster or multiple computing machines capable of communicating over a communication connection. Thus, the electronic device 500 may operate in a networked environment using logical connections with one or more other servers, network personal computers (PCs), or another network node.

The input device 550 may be one or more input devices, such as a mouse, a keyboard, a trackball, or the like. The output device 560 may be one or more output devices, such as a display, a speaker, a printer, or the like. The electronic device 500 may also communicate with one or more external devices (not shown) through the communication unit 540 as needed, external devices such as storage devices, display devices, etc., communicate with one or more devices that enable a user to interact with the electronic device 500, or communicate with any device (e.g., a network card, a modem, etc.) that enables the electronic device 500 to communicate with one or more other electronic devices. Such communication may be performed via an input/output (I/O) interface (not shown).

According to example implementations of the present disclosure, there is provided a computer-readable storage medium having computer-executable instructions stored thereon, wherein the computer-executable instructions are executed by a processor to implement the method described above. According to example implementations of the present disclosure, a computer program product is further provided, the computer program product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer program products implemented in accordance with the present disclosure. It should be understood that each block of the flowchart and/or block diagram, and combinations of blocks in the flowcharts and/or block diagrams, may be implemented by computer readable program instructions.

These computer-readable program instructions may be provided to a processing unit of a general purpose computer, special purpose computer, or other programmable data processing apparatus to produce a machine, such that the instructions, when executed by a processing unit of a computer or other programmable data processing apparatus, produce means to implement the functions/acts specified in the flowchart and/or block diagram. These computer-readable program instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block diagram(s).

The computer-readable program instructions may be loaded onto a computer, other programmable data processing apparatus, or other apparatus, such that a series of operational steps are performed on a computer, other programmable data processing apparatus, or other apparatus to produce a computer-implemented process such that the instructions executed on a computer, other programmable data processing apparatus, or other apparatus implement the functions/acts specified in the flowchart and/or block diagram block or blocks.

The flowchart and block diagrams in the figures show architecture, functionality, and operation of possible implementations of systems, methods, and computer program products according to various implementations of the present disclosure. In this regard, each block in the flowchart or block diagram may represent a module, program segment, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are exemplary, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, practical applications, or improvements to techniques in the marketplace, or to enable others of ordinary skill in the art to understand the various implementations disclosed herein.

1. A method for data rate measurement, comprising:
transmitting a first probing packet to a server based on a first transmission rate for the first probing packet, wherein the first probing packet is configured to simulate media information transmitted in a media information transmission scenario;
transmitting a second probing packet to the server based on a second transmission rate for the second probing packet, wherein a data amount of the second probing packet is less than a data amount of the first probing packet, and the second transmission rate is determined based on the first transmission rate;
obtaining, within a time period, a first rate measurement result associated with the first probing packet and a second rate measurement result associated with the second probing packet; and
determining a rate measurement result corresponding to the transmitted media information based on the first rate measurement result and the second rate measurement result.

2. The method of claim 1, wherein the second transmission rate is determined by:
obtaining an exponential growth function of a preset probing period and a congestion control window size for the first probing packet; and
determining the second transmission rate based on the exponential growth function, the congestion control window size, and the first transmission rate.

3. The method of claim 1, wherein transmitting the second probing packet to the server comprises:
determining a probing period for the second probing packet based on an exponential growth function of a preset probing period and a minimum round-trip time measured for the first probing packet; and
transmitting the second probing packet to the server at the second transmission rate according to the probing period for the second probing packet.

4. The method of claim 1, wherein the time period comprises a plurality of time units, and transmitting the first probing packet and the second probing packet to the server comprises:
for a time unit of the plurality of time units,
transmitting the second probing packet to the server at the second transmission rate within a first probing period; and
transmitting the first probing packet to the server at the first transmission rate within a second probing period after the first probing period.

5. The method of claim 4, wherein obtaining the second rate measurement result associated with the second probing packet comprises:
determining, for each of the plurality of time units, a candidate rate measurement result based on a second acknowledgment message of the server for the second probing packet, to derive a plurality of candidate rate measurement results respectively corresponding to the plurality of time units; and
determining the second rate measurement result based on the plurality of candidate rate measurement results.

6. The method of claim 5, wherein determining the candidate rate measurement result comprises:
determining a data amount of the second probing packet in response to receiving the second acknowledgment message; and
determining the candidate rate measurement result based on the data amount and the first probing period.

7. The method of claim 4, wherein transmitting the first probing packet to the server comprises:
generating the first probing packet by an application layer of a client device, the client device associated with a transmission initiator of the media information transmission scenario; and
transmitting, by a transport layer of the client device, the first probing packet to the server based on the first transmission rate for the first probing packet.

8. The method of claim 7, wherein obtaining the first rate measurement result associated with the first probing packet comprises:
determining, for each of the plurality of time units, a transport layer rate measurement result based on a first acknowledgment message, of the server, received by the transport layer of the client device for the first probing packet, to derive a plurality of transport layer rate measurement results respectively corresponding to the plurality of time units; and
determining at least one application layer rate measurement result based on the plurality of transport layer rate measurement results; and
determining the first rate measurement result based on the at least one application layer rate measurement result.

9. The method of claim 1, wherein determining a rate measurement result corresponding to the transmitted media information comprises:
using the second rate measurement result as the rate measurement result in accordance with that a duration of the time period is less than a first duration threshold and greater than a second duration threshold; and
determining the rate measurement result based on the first rate measurement result, the second rate measurement result, and a preset confidence factor in accordance with that the duration of the time period is greater than the first duration threshold and less than a third duration threshold.

10. The method of claim 1, wherein determining a rate measurement result corresponding to the transmitted media information comprises:
using the first rate measurement result as the rate measurement result in accordance with that a duration of the time period is greater than or equal to a second duration threshold and a minimum round-trip time measured for the first probing packet is less than a fourth duration threshold; and
using the second rate measurement result as the rate measurement result in accordance with that the duration of the time period is greater than or equal to the second duration threshold and the minimum round-trip time measured for the first probing packet is greater than or equal to the fourth duration threshold.

11. The method of claim 1, further comprising:
determining an image resolution for the transmitted media information based on the rate measurement result.

12. An electronic device, comprising:
at least one processor; and
at least one memory coupled to the at least one processor and storing instructions for execution by the at least one processor, the instructions, when executed by the at least one processor, cause the electronic device to perform acts comprising:
transmitting a first probing packet to a server based on a first transmission rate for the first probing packet, wherein the first probing packet is configured to simulate media information transmitted in a media information transmission scenario;
transmitting a second probing packet to the server based on a second transmission rate for the second probing packet, wherein a data amount of the second probing packet is less than a data amount of the first probing packet, and the second transmission rate is determined based on the first transmission rate;
obtaining, within a time period, a first rate measurement result associated with the first probing packet and a second rate measurement result associated with the second probing packet; and
determining a rate measurement result corresponding to the transmitted media information based on the first rate measurement result and the second rate measurement result.

13. The electronic device of claim 12, wherein the second transmission rate is determined by:
obtaining an exponential growth function of a preset probing period and a congestion control window size for the first probing packet; and
determining the second transmission rate based on the exponential growth function, the congestion control window size, and the first transmission rate.

14. The electronic device of claim 12, wherein transmitting the second probing packet to the server comprises:
determining a probing period for the second probing packet based on an exponential growth function of a preset probing period and a minimum round-trip time measured for the first probing packet; and
transmitting the second probing packet to the server at the second transmission rate according to the probing period for the second probing packet.

15. The electronic device of claim 12, wherein the time period comprises a plurality of time units, and transmitting the first probing packet and the second probing packet to the server comprises:
for a time unit of the plurality of time units,
transmitting the second probing packet to the server at the second transmission rate within a first probing period; and
transmitting the first probing packet to the server at the first transmission rate within a second probing period after the first probing period.

16. The electronic device of claim 15, wherein obtaining the second rate measurement result associated with the second probing packet comprises:
determining, for each of the plurality of time units, a candidate rate measurement result based on a second acknowledgment message of the server for the second probing packet, to derive a plurality of candidate rate measurement results respectively corresponding to the plurality of time units; and
determining the second rate measurement result based on the plurality of candidate rate measurement results.

17. The electronic device of claim 16, wherein determining the candidate rate measurement result comprises:
determining a data amount of the second probing packet in response to receiving the second acknowledgment message; and
determining the candidate rate measurement result based on the data amount and the first probing period.

18. The electronic device of claim 15, wherein transmitting the first probing packet to the server comprises:
generating the first probing packet by an application layer of a client device, the client device associated with a transmission initiator of the media information transmission scenario; and
transmitting, by a transport layer of the client device, the first probing packet to the server based on the first transmission rate for the first probing packet.

19. The electronic device of claim 18, wherein obtaining the first rate measurement result associated with the first probing packet comprises:
determining, for each of the plurality of time units, a transport layer rate measurement result based on a first acknowledgment message, of the server, received by the transport layer of the client device for the first probing packet, to derive a plurality of transport layer rate measurement results respectively corresponding to the plurality of time units; and
determining at least one application layer rate measurement result based on the plurality of transport layer rate measurement results; and
determining the first rate measurement result based on the at least one application layer rate measurement result.

20. A non-transitory computer-readable storage medium having a computer program stored thereon, wherein the computer program is executable by a processor to implement a method comprising:
transmitting a first probing packet to a server based on a first transmission rate for the first probing packet, wherein the first probing packet is configured to simulate media information transmitted in a media information transmission scenario;
transmitting a second probing packet to the server based on a second transmission rate for the second probing packet, wherein a data amount of the second probing packet is less than a data amount of the first probing packet, and the second transmission rate is determined based on the first transmission rate;
obtaining, within a time period, a first rate measurement result associated with the first probing packet and a second rate measurement result associated with the second probing packet; and
determining a rate measurement result corresponding to the transmitted media information based on the first rate measurement result and the second rate measurement result.
